(19) United States
(12) Patent Application Publication
(10) Pub. No.: US 2026/0190050 A1
(43) Pub. Date: Jul. 2, 2026

(54) COMMUNICATION METHOD AND RELATED APPARATUS

(71) Applicant: HUAWEI TECHNOLOGIES CO., LTD., Shenzhen (CN)

(72) Inventors: Dongdong Wei, Shenzhen (CN); Hao Tang, Shanghai (CN); Liqing Zhang, Ottawa (CA); Jianglei Ma, Ottawa (CA)

(21) Appl. No.: 19/535,106

(22) Filed: Feb. 10, 2026

Related U.S. Application Data
(63) Continuation of application No. PCT/CN2023/112488, filed on Aug. 11, 2023.

(51) Int. Cl. H04W 56/00; H04W 52/02; H04W 72/0446; H04W 72/0453

(52) U.S. Cl. CPC H04W 56/0015; H04W 52/0235; H04W 72/0446; H04W 72/0453

(57) ABSTRACT

A communication method and a related apparatus are provided. The method includes: A terminal device receives a downlink synchronization signal from an access network device, where the downlink synchronization signal is used for downlink synchronization; and the terminal device sends a wake up signal to the access network device, where the wake up signal indicates assistance information, and the assistance information is used to trigger the access network device to send all or a part of information in system information. Embodiments of this application help reduce network energy consumption.

### CROSS-REFERENCE TO RELATED APPLICATIONS

This application is a continuation of International Application No. PCT/CN2023/112488, filed on Aug. 11, 2023, the disclosure of which is hereby incorporated by reference in its entirety.

### TECHNICAL FIELD

This application relates to the field of communication technologies, and in particular, to a communication method and a related apparatus.

### BACKGROUND

To satisfy increasing traffic requirements of people, wireless networks are being rapidly constructed. As the network scale increases, network energy consumption increases continuously, and electricity fees greatly increase costs of operators. In a current network, different equipment vendors and operators use various energy saving methods, for example, including equipment-level, site-level, and network-level energy saving. In addition, the 3rd generation partnership project (3GPP) version 18 also carries out research on network energy saving. Energy saving solutions related to a synchronization signal and a physical broadcast channel block (synchronization signal and PBCH block, SSB)/system information block 1 (SIB 1) mainly include: extending an SSB periodicity, sending a simplified SSB, sending an SSB/SIB on demand, and the like. An example in which the SSB/SIB is sent on demand is used. It is considered by default that only the SSB or the simplified SSB is broadcast. After a wake up signal (WUS) sent by a terminal device is received, sending of the SSB and the SIB is started (for a period of time). Because the SSB and the SIB of a cell are no longer always-on signals but are sent on demand, a quantity of symbols used to send the SSB and the SIB may be greatly reduced, to increase a time-domain muting opportunity and reduce power consumption. However, how to further refine the energy saving solution related to the SSB/SIB 1 has not been discussed.

### SUMMARY

This application provides a communication method and a related apparatus, to help reduce network energy consumption.

According to a first aspect, this application provides a communication method, and the method is performed by a terminal device. The terminal device may be the terminal device, or may be a unit or module (for example, a chip) that has a corresponding function in the terminal device. In the method, the terminal device receives a downlink synchronization signal from an access network device, where the downlink synchronization signal is used for downlink synchronization; and the terminal device sends a wake up signal to the access network device, where the wake up signal indicates assistance information, and the assistance information is used to trigger the access network device to send all or a part of information in system information.

In this application, the wake up signal indicates the assistance information, and the assistance information is used to trigger on-demand sending of all or a part of content in the system information, so that overheads of the system information can be reduced, to help reduce network energy consumption.

In a possible implementation, the wake up signal includes first indication information, and the first indication information indicates the assistance information.

In this implementation, the first indication information may be added to the wake up signal to indicate the assistance information. In this way, the assistance information may be explicitly indicated.

In a possible implementation, different wake up signals indicate different assistance information, and an association relationship between different wake up signals and different assistance information is predefined, or preconfigured, or indicated by a first message.

In this implementation, the wake up signal may indicate the assistance information, where different wake up signals indicate different assistance information. This implicit indication manner helps reduce signaling overheads.

In a possible implementation, the wake up signal is an orthogonal sequence, and different orthogonal sequences indicate different assistance information.

In this implementation, the wake up signal may be the orthogonal sequence. This manner of carrying information by using mutually orthogonal sequences helps reduce complexity of signal receiving and detection.

In a possible implementation, the wake up signal is a chirp signal, and that the different wake up signals indicate the different assistance information includes:

Chirp signals with different start frequencies indicate different assistance information.

In this implementation, the wake up signal may be the chirp signal. This manner of receiving and sending a signal in an analog domain-based low power consumption manner helps reduce energy consumption.

In a possible implementation, that the different wake up signals indicate the different assistance information includes:

Different time domain offset values indicate different assistance information, where the time domain offset value is a time domain offset of a time domain resource that the wake up signal is on relative to a time domain resource that the downlink synchronization signal is on; or
different frequency domain offset values indicate different assistance information, where the frequency domain offset value is a frequency domain offset of a frequency domain resource that the wake up signal is on relative to a frequency domain resource that the downlink synchronization signal is on.

In this implementation, the assistance information may be indicated by a resource offset value (for example, the time domain offset value or the frequency domain offset value) between the wake up signal and the downlink synchronization signal, and implementation solutions are diversified.

In a possible implementation, the assistance information includes one or more of a service type, service quality of service, downlink signal received quality information, and a wake up signal type.

In this implementation, the assistance information may be specifically a parameter that meets an actual requirement, like the service type, the service quality of service, the downlink signal received quality information, or the wake up signal type. Therefore, the access network device may send the system information based on the actual requirement, and applicability is high.

In a possible implementation, the service type includes one or more of reduced capability Redcap, enhanced mobile broadband (eMBB), ultra-reliable low-latency communication (URLLC), and small data transmission (SDT).

In this implementation, when the service type is Redcap, the access network device may send Redcap-related configuration information to the terminal device. When the service type is eMBB, the access network device may send eMBB-related configuration information to the terminal device. When the service type is URLLC, the access network device may send URLLC-related configuration information to the terminal device. When the service type is SDT, the access network device may send SDT-related configuration information to the terminal device. Compared with a manner in which the access network device broadcasts the configuration information corresponding to all the service types in a conventional technology, this on-demand sending manner in this application helps reduce network energy consumption.

In a possible implementation, the downlink signal received quality information is downlink signal received quality, a signal quality range to which the downlink signal received quality belongs, or indication information indicating whether the downlink signal received quality is greater than a signal quality threshold.

In this implementation, the signal quality range to which the downlink signal received quality belongs or the indication information indicating whether the downlink signal received quality is greater than the signal quality threshold is reported as the downlink signal received quality information, so that signaling overheads can be reduced, and the downlink signal received quality is reported as the downlink signal received quality information, so that accuracy is higher although signaling overheads are greater.

In a possible implementation, that the assistance information is used to trigger the access network device to send the part of information in the system information includes:

The assistance information is used to trigger the access network device to send a first part of information, a second part of information, or a first tag value in the system information, the first tag value is used to determine whether the system information stored in a terminal device is valid, and all the information in the system information includes the first part of information, the second part of information, and the first tag value.

In a possible implementation, the first part of information includes one or two of an S criterion and cell access-related information; and the second part of information includes one or two of radio resource common configuration information and timer configuration information.

In a possible implementation, the system information is a master information block MIB and/or a system information block SIB 1.

In a possible implementation, the assistance information includes the wake up signal type; and the sending the wake up signal to the access network device includes:
sending a third-type wake up signal to the access network device, where the third-type wake up signal is used to trigger the access network device to send the first part of information; and
the method further includes:
receiving the first part of information from the access network device; and
when the terminal device can camp on the first cell, sending a fourth-type wake up signal to the access network device, where the fourth-type wake up signal is used to trigger the access network device to send the second part of information.

In this implementation, in a cell reselection scenario, the wake up signal may be sent in a 2-step manner, to obtain a needed system message and complete cell camping.

In a possible implementation, the assistance information includes the wake up signal type; and the sending the wake up signal to the access network device includes:
sending a second-type wake up signal to the access network device, where the second-type wake up signal is used to trigger the access network device to send the first tag value; and
the method further includes:
receiving the first tag value from the access network device; and
when it is determined, based on the first tag value, that a system message stored in the terminal device is invalid, sending a first-type wake up signal to the access network device, where the first-type wake up signal is used to trigger the access network device to send all information in the system message.

In this implementation, in a scenario in which the terminal device returns from out-of-coverage to in-coverage, the wake up signal may be sent in a 2-step manner, to obtain a needed system message.

According to a second aspect, this application provides a communication method, and the method is performed by a network device. The network device may be the network device, or may be a unit or module (for example, a chip) that has a corresponding function in the network device. In the method, the network device sends a downlink synchronization signal to a terminal device, where the downlink synchronization signal is used for downlink synchronization; and the network device receives a wake up signal from the terminal device, where the wake up signal indicates assistance information, and the assistance information is used to trigger an access network device to send all or a part of information in system information.

In a possible implementation, the wake up signal includes first indication information, and the first indication information indicates the assistance information.

In a possible implementation, different wake up signals indicate different assistance information, and an association relationship between different wake up signals and different assistance information is predefined, or preconfigured, or indicated by a first message.

In a possible implementation, the wake up signal is an orthogonal sequence, and different orthogonal sequences indicate different assistance information.

In a possible implementation, the wake up signal is a chirp signal, and that the different wake up signals indicate the different assistance information includes:

Chirp signals with different start frequencies indicate different assistance information.

In a possible implementation, that the different wake up signals indicate the different assistance information includes:

Different time domain offset values indicate different assistance information, where the time domain offset value is a time domain offset of a time domain resource that the wake up signal is on relative to a time domain resource that the downlink synchronization signal is on; or
different frequency domain offset values indicate different assistance information, where the frequency domain offset value is a frequency domain offset of a frequency domain resource that the wake up signal is on relative to a frequency domain resource that the downlink synchronization signal is on.

In a possible implementation, the assistance information includes one or more of a service type, service quality of service, downlink signal received quality information, and a wake up signal type.

In a possible implementation, the service type includes one or more of reduced capability Redcap, enhanced mobile broadband eMBB, ultra-reliable low-latency communication URLLC, and small data transmission SDT.

In a possible implementation, the downlink signal received quality information is downlink signal received quality, a signal quality range to which the downlink signal received quality belongs, or indication information indicating whether the downlink signal received quality is greater than a signal quality threshold.

In a possible implementation, that the assistance information is used to trigger the access network device to send the part of information in the system information includes:

The assistance information is used to trigger the access network device to send a first part of information, a second part of information, or a first tag value in the system information, the first tag value is used to determine whether the system information stored in a terminal device is valid, and all the information in the system information includes the first part of information, the second part of information, and the first tag value.

In a possible implementation, the first part of information includes one or two of an S criterion and cell access-related information; and the second part of information includes one or two of radio resource common configuration information and timer configuration information.

In a possible implementation, the system information is a master information block (MIB) and/or a system information block (SIB) 1.

In a possible implementation, the assistance information includes the wake up signal type; and the receiving the wake up signal from the terminal device includes:
receiving a third-type wake up signal from the terminal device, where the third-type wake up signal is used to trigger the access network device to send the first part of information; and
the method further includes:
sending the first part of information to the terminal device; and
receiving a fourth-type wake up signal from the terminal device, where the fourth-type wake up signal is used to trigger the access network device to send the second part of information.

In a possible implementation, the assistance information includes the wake up signal type; and the receiving the wake up signal from the terminal device includes:
receiving a second-type wake up signal from the terminal device, where the second-type wake up signal is used to trigger the access network device to send the first tag value; and
the method further includes:
sending the first tag value to the terminal device; and
receiving a first-type wake up signal from the terminal device, where the first-type wake up signal is used to trigger the access network device to send all information in the system message.

According to a third aspect, this application provides a communication apparatus. The communication apparatus may be the communication apparatus, or a module, a chip, or a unit in the communication apparatus. The communication apparatus includes:
a transceiver unit, configured to receive a downlink synchronization signal from an access network device, where the downlink synchronization signal is used for downlink synchronization, where
the transceiver unit is configured to send a wake up signal to the access network device, where the wake up signal indicates assistance information, and the assistance information is used to trigger the access network device to send all or a part of information in system information.

In a possible implementation, the wake up signal includes first indication information, and the first indication information indicates the assistance information.

In a possible implementation, different wake up signals indicate different assistance information, and an association relationship between different wake up signals and different assistance information is predefined, or preconfigured, or indicated by a first message.

In a possible implementation, the wake up signal is an orthogonal sequence, and different orthogonal sequences indicate different assistance information.

In a possible implementation, the wake up signal is a chirp signal, and that the different wake up signals indicate the different assistance information includes:

Chirp signals with different start frequencies indicate different assistance information.

In a possible implementation, that the different wake up signals indicate the different assistance information includes:

Different time domain offset values indicate different assistance information, where the time domain offset value is a time domain offset of a time domain resource that the wake up signal is on relative to a time domain resource that the downlink synchronization signal is on; or
different frequency domain offset values indicate different assistance information, where the frequency domain offset value is a frequency domain offset of a frequency domain resource that the wake up signal is on relative to a frequency domain resource that the downlink synchronization signal is on.

In a possible implementation, the assistance information includes one or more of a service type, service quality of service, downlink signal received quality information, and a wake up signal type.

In a possible implementation, the service type includes one or more of reduced capability Redcap, enhanced mobile broadband eMBB, ultra-reliable low-latency communication URLLC, and small data transmission SDT.

In a possible implementation, the downlink signal received quality information is downlink signal received quality, a signal quality range to which the downlink signal received quality belongs, or indication information indicating whether the downlink signal received quality is greater than a signal quality threshold.

In a possible implementation, that the assistance information is used to trigger the access network device to send the part of information in the system information includes:

The assistance information is used to trigger the access network device to send a first part of information, a second part of information, or a first tag value in the system information, the first tag value is used to determine whether the system information stored in a terminal device is valid, and all the information in the system information includes the first part of information, the second part of information, and the first tag value.

In a possible implementation, the first part of information includes one or two of an S criterion and cell access-related information; and the second part of information includes one or two of radio resource common configuration information and timer configuration information.

In a possible implementation, the system information is a master information block MIB and/or a system information block SIB 1.

In a possible implementation, the assistance information includes the wake up signal type, and the transceiver unit is configured to:
send a third-type wake up signal to the access network device, where the third-type wake up signal is used to trigger the access network device to send the first part of information;
receive the first part of information from the access network device; and
when the terminal device can camp on the first cell, send a fourth-type wake up signal to the access network device, where the fourth-type wake up signal is used to trigger the access network device to send the second part of information.

In a possible implementation, the assistance information includes the wake up signal type, and the transceiver unit is configured to:
send a second-type wake up signal to the access network device, where the second-type wake up signal is used to trigger the access network device to send the first tag value;
receive the first tag value from the access network device; and
when it is determined, based on the first tag value, that a system message stored in the terminal device is invalid, send a first-type wake up signal to the access network device, where the first-type wake up signal is used to trigger the access network device to send all information in the system message.

According to a fourth aspect, this application provides a communication apparatus. The communication apparatus may be the communication apparatus, or a module, a chip, or a unit in the communication apparatus. The communication apparatus includes:
a transceiver unit, configured to send a downlink synchronization signal to a terminal device, where the downlink synchronization signal is used for downlink synchronization, where
the transceiver unit is configured to receive a wake up signal from the terminal device, where the wake up signal indicates assistance information, and the assistance information is used to trigger an access network device to send all or a part of information in system information.

In a possible implementation, the wake up signal includes first indication information, and the first indication information indicates the assistance information.

In a possible implementation, different wake up signals indicate different assistance information, and an association relationship between different wake up signals and different assistance information is predefined, or preconfigured, or indicated by a first message.

In a possible implementation, the wake up signal is an orthogonal sequence, and different orthogonal sequences indicate different assistance information.

In a possible implementation, the wake up signal is a chirp signal, and that the different wake up signals indicate the different assistance information includes:

Chirp signals with different start frequencies indicate different assistance information.

In a possible implementation, that the different wake up signals indicate the different assistance information includes:

Different time domain offset values indicate different assistance information, where the time domain offset value is a time domain offset of a time domain resource that the wake up signal is on relative to a time domain resource that the downlink synchronization signal is on; or
different frequency domain offset values indicate different assistance information, where the frequency domain offset value is a frequency domain offset of a frequency domain resource that the wake up signal is on relative to a frequency domain resource that the downlink synchronization signal is on.

In a possible implementation, the assistance information includes one or more of a service type, service quality of service, downlink signal received quality information, and a wake up signal type.

In a possible implementation, the service type includes one or more of reduced capability Redcap, enhanced mobile broadband eMBB, ultra-reliable low-latency communication URLLC, and small data transmission SDT.

In a possible implementation, the downlink signal received quality information is downlink signal received quality, a signal quality range to which the downlink signal received quality belongs, or indication information indicating whether the downlink signal received quality is greater than a signal quality threshold.

In a possible implementation, that the assistance information is used to trigger the access network device to send the part of information in the system information includes:

The assistance information is used to trigger the access network device to send a first part of information, a second part of information, or a first tag value in the system information, the first tag value is used to determine whether the system information stored in a terminal device is valid, and all the information in the system information includes the first part of information, the second part of information, and the first tag value.

In a possible implementation, the first part of information includes one or two of an S criterion and cell access-related information; and the second part of information includes one or two of radio resource common configuration information and timer configuration information.

In a possible implementation, the system information is a master information block MIB and/or a system information block SIB 1.

In a possible implementation, the assistance information includes the wake up signal type, and the transceiver unit is configured to:
receive a third-type wake up signal from the terminal device, where the third-type wake up signal is used to trigger the access network device to send the first part of information;
send the first part of information to the terminal device; and
receive a fourth-type wake up signal from the terminal device, where the fourth-type wake up signal is used to trigger the access network device to send the second part of information.

In a possible implementation, the assistance information includes the wake up signal type, and the transceiver unit is configured to:
receive a second-type wake up signal from the terminal device, where the second-type wake up signal is used to trigger the access network device to send the first tag value;
send the first tag value to the terminal device; and
receive a first-type wake up signal from the terminal device, where the first-type wake up signal is used to trigger the access network device to send all information in the system message.

According to a fifth aspect, this application provides a communication apparatus. The communication apparatus includes a processor, and the processor is configured to execute a computer program, to cause the communication apparatus to perform the method in any possible implementation in either the first aspect or the second aspect.

In a possible implementation, the communication apparatus may be a chip implementing the method in either the first aspect or the second aspect or a device including the chip.

In a possible implementation, the communication apparatus further includes a transceiver. The processor is coupled to the transceiver.

In a possible implementation, the communication apparatus further includes a memory. The processor is coupled to the memory, the memory stores a computer program, and the processor is further configured to invoke the computer program in the memory. Optionally, the processor and the memory are integrated together.

According to a sixth aspect, this application provides a communication apparatus. The communication apparatus includes a processor and an interface circuit. The interface circuit is configured to: receive a signal from a communication apparatus other than the communication apparatus and transmit the signal to the processor, or send a signal from the processor to a communication apparatus other than the communication apparatus. The processor is configured to implement the method in any possible implementation in either the first aspect or the second aspect by using a logic circuit or by executing code instructions.

According to a seventh aspect, this application provides a computer-readable storage medium. The storage medium stores a computer program or instructions. When the computer program or the instructions are executed by a computer, the method in any possible implementation in either the first aspect or the second aspect is implemented.

According to an eighth aspect, this application provides a computer program product. When a computer reads and executes the computer program product, the computer is caused to perform the method in any possible implementation in either the first aspect or the second aspect.

According to a ninth aspect, this application provides a communication system. The communication system includes a communication apparatus configured to implement the method in any possible implementation in the first aspect, and includes a communication apparatus configured to implement the method in any possible implementation in the second aspect.

For beneficial effects of the second aspect to the ninth aspect, refer to the beneficial effects of the first aspect.

### BRIEF DESCRIPTION OF DRAWINGS

FIG. 1 is a diagram of an architecture of a communication system to which an example embodiment of this application is applied;

FIG. 2 is an example diagram of periodic sending of a SIB 1 in LTE;

FIG. 3 is an example diagram of sending an SSB/SIB on demand;

FIG. 4 is a flowchart of an interaction procedure of a communication method according to an example embodiment of this application;

FIG. 5 is a diagram of 1-step system information obtaining according to an example embodiment of this application;

FIG. 6 is a diagram of 2-step system information obtaining according to an example embodiment of this application;

FIG. 7 is a diagram of an association relationship between first indication information and assistance information according to an example embodiment of this application;

FIG. 8 is a diagram of an association relationship between first indication information and assistance information according to an example embodiment of this application;

FIG. 9 is a diagram of an association relationship between first indication information and assistance information according to an example embodiment of this application;

FIG. 10 is a diagram of an association relationship between an orthogonal sequence and assistance information according to an example embodiment of this application;

FIG. 11 is a diagram of chirp signals with different start frequencies according to an example embodiment of this application;

FIG. 12 is a diagram of wake up signals on different transmission resources according to an example embodiment of this application;

FIG. 13 is a diagram of a possible structure of a communication apparatus according to an example embodiment of this application; and

FIG. 14 is a diagram of a possible structure of a communication apparatus according to an example embodiment of this application.

### DESCRIPTION OF EMBODIMENTS

The following further describes specific embodiments of this application in detail with reference to accompanying drawings.

Terms “first”, “second”, and the like in this specification, the claims, and the accompanying drawings of this application are used to distinguish between different objects, but are not used to describe a specific sequence. In addition, the terms “including” and “having” and any other variants thereof are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

“Embodiments” mentioned herein mean that specific features, structures, or characteristics described in combination with embodiments may be included in at least one embodiment of this application. The phrase shown in various locations in the specification may not necessarily refer to a same embodiment, and is not an independent or optional embodiment exclusive from another embodiment. It is explicitly and implicitly understood by a person skilled in the art that embodiments described in the specification may be combined with another embodiment.

In this application, “at least one (item)” means one or more, “a plurality of” means two or more, “at least two (items)” means two or three or more, and “and/or” is used to describe an association relationship between associated objects, which indicates that at least three relationships may exist. For example, “A and/or B” may indicate: only A exists, only B exists, and both A and B exist. A and B may be singular or plural. The character “/” usually indicates an “or” relationship between the associated objects. The expression “at least one of the following items (pieces)” or a similar expression means any combination of these items, including a single item (piece) or any combination of a plurality of items (pieces). For example, at least one of a, b, or c may indicate a, b, c, a and b, a and c, b and c, or a, b, and c, where a, b, and c may be singular or plural.

To better understand embodiments of this application, the following first describes a system architecture in embodiments of this application.

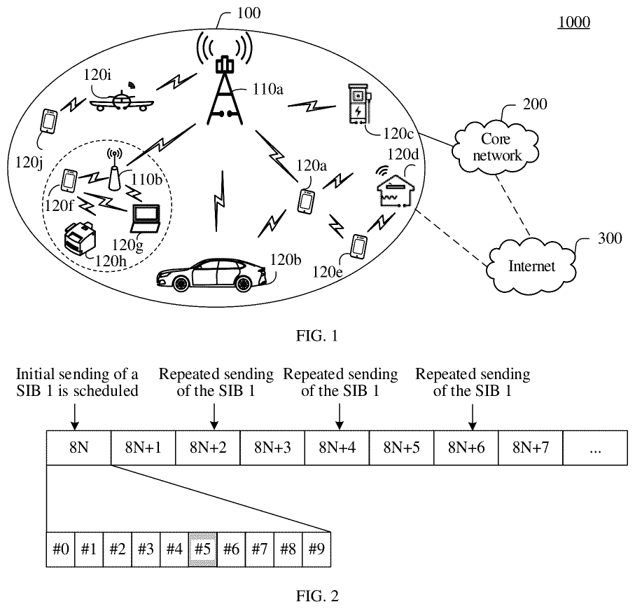

FIG. 1 is a diagram of an architecture of a communication system to which an embodiment of this application is applied. As shown in FIG. 1, the communication system 1000 includes a radio access network (RAN) 100 and a core network (CN) 200. Optionally, the communication system 1000 may further include an internet 300. The RAN 100 includes at least one RAN node (for example, 110a and 110b in FIG. 1, which are collectively referred to as 110) and at least one terminal (for example, 120a to 120j in FIG. 1, which are collectively referred to as 120). The RAN 100 may further include another RAN node, for example, a wireless relay device and/or a wireless backhaul device (not shown in FIG. 1). The terminal 120 is connected to the RAN node 110 in a wireless manner. The RAN node 110 is connected to the core network 200 in a wireless or wired manner. A core network device in the core network 200 and the RAN node 110 in the RAN 100 may respectively be different physical devices, or may be a same physical device that integrates a logical function of the core network and a logical function of the radio access network.

The RAN 100 may be a cellular system related to the 3rd generation partnership project (3GPP), for example, a 4G or 5G mobile communication system, or a future-oriented evolved system (for example, a 6G mobile communication system). The RAN 100 may alternatively be an open access network (open RAN, O-RAN or ORAN), a cloud radio access network (CRAN), or a wireless fidelity (Wi-Fi) system. The RAN 100 may alternatively be a communication system that integrates two or more of the foregoing systems.

The RAN node 110 may also be referred to as an access network device, a RAN entity, an access node, or the like sometimes, and forms a part of the communication system, to help the terminal implement radio access. A plurality of RAN nodes 110 in the communication system 1000 may be nodes of a same type, or may be nodes of different types. In some scenarios, roles of the RAN node 110 and the terminal 120 are relative to each other. For example, the network element 120i in FIG. 1 may be a helicopter or an uncrewed aerial vehicle, and may be configured as a mobile base station. For the terminal 120j that accesses the RAN 100 via the network element 120i, the network element 120i is a base station. However, for the base station 110a, the network element 120i is a terminal. The RAN node 110 and the terminal 120 are sometimes both referred to as communication apparatuses. For example, the base stations 110a and 110b in FIG. 1 may be understood as communication apparatuses having a base station function, and the terminals 120a to 120j may be understood as communication apparatuses having a terminal function.

In a possible scenario, the RAN node may be a base station, an evolved NodeB (eNodeB), an access point (AP), a transmission reception point (TRP), a next generation NodeB (gNB), a next generation base station in a 6th generation (6G) mobile communication system, a base station in a future mobile communication system, an access node in a Wi-Fi system, or the like. The RAN node may be a macro base station (for example, 110a in FIG. 1), a micro base station or an indoor station (for example, 110b in FIG. 1), a relay node or a donor node, or a radio controller in a CRAN scenario. Optionally, the RAN node may alternatively be a server, a wearable device, a vehicle, a vehicle-mounted device, or the like. For example, an access network device in a vehicle to everything (V2X) technology may be a road side unit (RSU). All or some functions of the RAN node in this application may alternatively be implemented by using a software function running on hardware, or may be implemented by using an instantiated virtualization function on a platform (for example, a cloud platform). Alternatively, the RAN node in this application may be a logical node, a logical module, or software that can implement all or some functions of the RAN node.

In another possible scenario, a plurality of RAN nodes collaborate to assist the terminal in implementing radio access, and different RAN nodes separately implement some functions of the base station. For example, the RAN node may be a central unit (CU), a distributed unit (DU), a CU-control plane (CP), a CU-user plane (UP), or a radio unit (RU). The CU herein completes functions of a radio resource control protocol and a packet data convergence protocol (PDCP) of a base station, and may further complete a function of a service data adaptation protocol (SDAP). The DU completes functions of a radio link control layer and a medium access control (MAC) layer of a base station, and may further complete a part or all of functions of a physical layer. For detailed descriptions of the foregoing protocol layers, refer to technical specifications related to the 3rd generation partnership project (3GPP). The CU and the DU may be separately arranged, or may be included in a same network element, for example, a baseband unit (BBU). The RU may be included in a radio frequency device or a radio frequency unit, for example, included in a remote radio unit (RRU), an active antenna unit (AAU), or a remote radio head (RRH).

Optionally, the RAN node may also be referred to by different names, for example, an access network device. In this application, unless otherwise specified, the access network device is used for expression.

In different systems, the CU (or the CU-CP and the CU-UP), the DU, or the RU may also have different names, but a person skilled in the art may understand meanings thereof. For example, in an ORAN system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this application. Any one of the CU (or the CU-CP and the CU-UP), the DU, and the RU in this application may be implemented by using a software module, a hardware module, or a combination of a software module and a hardware module.

The terminal may also be referred to as a terminal device, user equipment (UE), a mobile station, a mobile terminal, mobile equipment (ME), or the like. The terminal may be widely used in various scenarios, for example, device-to-device (D2D), vehicle-to-everything (V2X) communication, machine-type communication (MTC), internet of things (IoT), virtual reality, augmented reality, industrial control, automatic driving, telemedicine, a smart grid, smart furniture, a smart office, smart wearable, smart transportation, and a smart city. The terminal may be a mobile phone, a tablet computer, a computer having a wireless transceiver function, a wearable device, a vehicle, an uncrewed aerial vehicle, a helicopter, an airplane, a ship, a robot, a mechanical arm, a smart home device, or the like. A device form of the terminal is not limited in embodiments of this application.

The core network may include one or more function entities (which is also referred to as a core network element, a network element, an entity, or the like), for example, a network slice selection function (NSSF), a network exposure function (NEF), a network repository function (NRF), a policy control function (PCF), a unified data management (UDM), an access and mobility management function (AMF), an authentication server function (AUSF), and a session management function (SMF).

It should be noted that the foregoing function entities are merely names, and the names do not constitute a limitation on the entities. For example, the session management function may alternatively be replaced with a “session management function entity” or another name. In addition, the session management function entity may alternatively correspond to an entity that includes another function in addition to the session management function. A user plane function may alternatively be replaced with a “user plane function entity” or another name. In addition, the user plane function entity may alternatively correspond to an entity that includes another function in addition to the user plane function.

It should be noted that a name of a message between network elements, a name of each parameter in the message, and the like in the following embodiments of this application are merely examples. There may alternatively be other names during specific implementation. This is not specifically limited in embodiments of this application.

In this application, “sending information to . . . (the terminal)” may be understood as that a destination end of the information is the terminal, and may include directly or indirectly sending the information to the terminal. “Receiving information from . . . (the terminal)” may be understood as that a source end of the information is the terminal, and may include directly or indirectly receiving the information from the terminal. Information may undergo necessary processing, for example, a format change, between the source end and the destination end of information sending. However, the destination end may understand valid information from the source end.

It should be understood that the terminal device in embodiments of this application may be any one of the foregoing devices or chips. This is not specifically limited herein. Regardless of being used as the device or the chip, the terminal device may be manufactured, sold, or used as an independent product. In this embodiment and subsequent embodiments, only the terminal device is used as an example for description.

It should be understood that, in embodiments of this application, an apparatus configured to implement a function of the access network device may be the access network device, or may be an apparatus that can support the access network device in implementing the function, for example, a chip system, or a combined device or component that can implement the function of the access network device. The apparatus may be installed in the access network device. In embodiments of this application, the chip system may include a chip, or may include a chip and another discrete component. In this embodiment and subsequent embodiments, only the access network device is used as an example for description.

The following explains and describes related technical features in embodiments of this application. It should be noted that these explanations are intended to make embodiments of this application easier to understand, but should not be considered as a limitation on the protection scope claimed in this application.

### 1. System Information (SI)

In a long term evolution (LTE) system, the SI may be classified into two types: a master information block (MIB) and a plurality of system information blocks (SIBs). The SIBs mainly include a SIB 1 to a SIB 21 (a new system information block may be introduced in a future version). In an LTE system, the MIB is carried on a physical broadcast channel (PBCH). A sending periodicity of the MIB is a fixed periodicity, where the fixed periodicity is 40 ms. The MIB is repeatedly sent within the 40 ms, and is sent once in each radio frame, that is, sent four times in one periodicity. The SIB 1 is carried on a physical downlink shared channel (PDSCH). A sending periodicity of the SIB 1 is also a fixed periodicity, where the fixed periodicity is 80 ms. The SIB 1 is sent once in a subframe 5 in each even-numbered radio frame, that is, sent four times in one periodicity, as shown in FIG. 2. For other SIBs (for example, the SIB 2 to the SIB 21), sending of the other SIBs may be scheduled by using the SIB 1, that is, the SIB 1 indicates periodicities and time domain start positions of the other SIBs.

In the LTE system, the SIB 1 includes cell access-related information, cell selection information (that is, an S criterion), and the like, and the SIB 2 includes radio resource common configuration information, timer configuration information, and the like.

In a new radio (NR) system, the SI may be classified into three types: the MIB, the SIB 1, and other system information (OSI). The SIB 1 may also be described as remaining minimum system information (RMSI). The OSI includes SIBs other than the SIB 1, for example, the SIB 2 to the SIB 21, and more SIBs that may be extended subsequently. The MIB being carried on the PBCH and bound to the synchronization signal is referred to as an SSB. The SSB is implemented based on a network, and a periodicity of the SSB is variable. A periodicity of the SIB 1 is 160 ms. During this periodicity, a quantity of repetitions is variable, and a default repetition periodicity is 20 ms. A specific repetition periodicity depends on network implementation and a multiplexing format of the SSB and a CORESET. For example, three multiplexing styles/patterns of the SSB and the CORESET are defined in the protocol. For a pattern 1, a repetition periodicity of the SIB 1 is 20 ms. For a pattern 2 and a pattern 3, a repetition periodicity of the SIB 1 is the same as a sending periodicity of the SSB.

Different from that in the LTE system, the SIB 1 in the NR system includes more information content, for example, cell access-related information, cell selection information (that is, an S criterion), radio resource common configuration information, timer configuration information, and related configuration information for different types of terminal devices or services.

### 2. Scheduling of Type A and Type B

During time domain resource allocation, two different time domain resource allocation manners are defined in NR: Type A and Type B. The two manners correspond to different time domain scheduling units. A time domain scheduling unit corresponding to Type A is a slot, and a time domain scheduling unit corresponding to Type B is a non-slot.

### 3. Chirp Signal

The chirp signal is a signal whose frequency changes linearly with time. The change herein may be a frequency increase or a frequency decrease. If such a signal is converted into audio, it sounds like chirps of a bird, and therefore, the signal is referred to as a chirp signal.

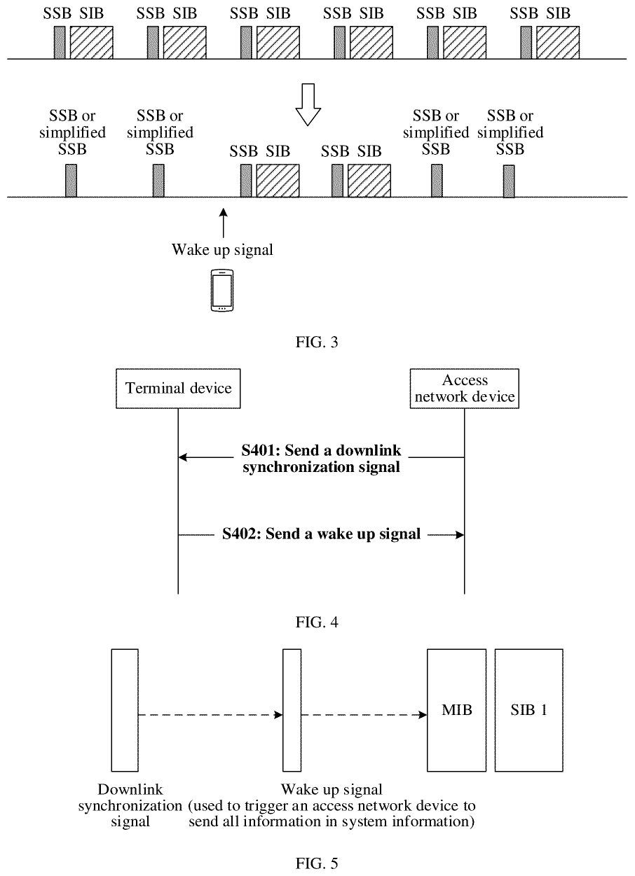

To achieve network energy saving, different equipment vendors and operators use various energy saving methods, for example, including equipment-level, site-level, and network-level energy saving. In addition, 3GPP Rel-18 also carries out research on network energy saving. Energy saving solutions related to an SSB/a SIB 1 mainly include extending an SSB periodicity, sending a simplified SSB, sending the SSB/SIB on demand, and the like. As shown in FIG. 3, an example in which the SSB/SIB is sent on demand is used. By default, only the SSB or the simplified SSB is broadcast. After a WUS sent by a terminal device is received, sending of the SSB and the SIB is started (for a period of time). Because the SSB and the SIB of a cell are no longer always-on signals but are sent on demand, a quantity of symbols used to send the SSB and the SIB may be greatly reduced, to increase a time-domain muting opportunity and reduce power consumption. However, all information of the SSB/SIB is currently sent on demand. For example, on-demand sending of the SIB 1 is used as an example. Cell access-related information, cell selection information (that is, an S criterion), radio resource common configuration information, timer configuration information, and related configuration information for different types of terminal devices or services that are included in the SIB 1 are all sent. When there is no terminal device or service of a related type in a coverage area, unnecessary message broadcast and resource waste are caused, and energy consumption of a network side is increased.

Based on this, this application provides a communication method, to help reduce network energy consumption.

The following describes in detail a communication method and a communication apparatus provided in this application.

FIG. 4 is a flowchart of an interaction procedure of a communication method according to an embodiment of this application. As shown in FIG. 4, the communication method includes the following step S401 and S402. The method shown in FIG. 4 may be performed by a terminal device and an access network device, or the method shown in FIG. 4 may be performed by a chip in the terminal device and a chip in the access network device. For ease of description, an example in which the method is performed by the terminal device and the access network device is mainly used for description in FIG. 4. It should be noted that FIG. 4 is a schematic flowchart of a method embodiment of this application, and shows detailed communication steps or operations of the method. However, these steps or operations are merely examples. Other operations or variants of various operations in FIG. 4 may be further performed in embodiments of this application. In addition, the steps in FIG. 4 may be separately performed in a sequence different from that shown in FIG. 4, and possibly, not all operations in FIG. 4 need to be performed. Specifically:

S401: An access network device sends a downlink synchronization signal to a terminal device. Correspondingly, the terminal device receives the downlink synchronization signal from the access network device.

In some feasible implementations, the terminal device may perform downlink synchronization based on the received downlink synchronization signal. The downlink synchronization signal may be a primary synchronization signal (PSS) and a secondary synchronization signal (SSS).

Optionally, the terminal device may further determine a manner of obtaining system information based on the received downlink synchronization signal. There are two obtaining manners herein: direct obtaining and indirect obtaining. For example, the downlink synchronization signal may carry 1-bit indication information. When a value of the 1 bit is 1, it indicates direct obtaining; when the value of the 1 bit is 0, it indicates indirect obtaining; and vice versa. This is not limited herein. Usually, when a network is busy (that is, there are a large quantity of online users and a large quantity of terminal services), the manner of direct obtaining may be used; and when the network is idle (that is, there are a small quantity of online users and a small quantity of terminal services), the manner of indirect obtaining may be used. It may be understood that, in the manner of direct obtaining, after completing the downlink synchronization, the access network device may send all the information in the system information; or in the manner of indirect obtaining, step S402 is performed.

S402: The terminal device sends a wake up signal to the access network device. Correspondingly, the access network device receives the wake up signal from the terminal device.

In some feasible implementations, the wake up signal may indicate assistance information, and the assistance information is used to trigger the access network device to send all or a part of information in the system information. Herein, the system information may be a MIB and/or a SIB 1. For ease of description, the following mainly uses an example in which the system information is the SIB 1 for understanding.

In some implementations 1, that the assistance information is used to trigger the access network device to send the part of information in the system information may be: The assistance information is used to trigger the access network device to send a first part, a second part, a first tag value, or the like of the system information. The first tag value is used to determine whether system information stored in the terminal device is valid. Usually, when a value of a value tag broadcast in the system information is the same as that of a value tag stored in the terminal device, it indicates that the system information stored in the terminal device is valid. When the value of the value tag broadcast in the system information is different from that of the value tag stored in the terminal device, it indicates that the system information stored in the terminal device is ineffective/invalid. Therefore, the system information needs to be obtained again.

It may be understood that all the information in the system information includes the first part of information, the second part of information, and the first tag value, or all the information in the system information includes the first part of information and the second part of information. For example, the first part of information includes one or two of an S criterion and cell access-related information; and the second part of information includes one or two of radio resource common configuration information and timer configuration information.

For example, the S criterion may specifically include one or more of a cell minimum receive level (q-RxLevMin), a cell minimum receive level offset (q-RxLevMinoffset), and the like.

For example, the cell access-related information may specifically include one or more of a public land mobile network identity list (plmn-IdentityList), a tracking area code, a cell identity, a cell barred identity, an intra-frequency neighboring cell reselection (intraFreqReselection) indicator, and the like.

For example, the radio resource common configuration information may specifically include one or more of reduced capability (Redcap)-related configuration information, enhanced mobile broadband (eMBB)-related configuration information, ultra-reliable ultra-low latency communication (URLLC)-related configuration information, small data transmission (SDT)-related configuration information, normal uplink (NUL)-related configuration information, supplementary uplink (SUL)-related configuration information, and the like. It should be noted that, NUL may alternatively be described as UL. For ease of distinguishing from the SUL, an expression manner of “NUL” is mainly used for uniform description subsequently.

For example, the timer configuration information may specifically include one or more of t300, t301, t310, n310, t311, n311, t319, and the like defined in 3GPP TS 38.331.

Usually, the terminal device may obtain, based on one step, the system information needed by the terminal device. As shown in FIG. 5, in scenarios such as cell selection, terminal power on, or initial acquisition, the terminal device may send, to the access network device, a wake up signal used to trigger the access network device to send all the information in the system information. Therefore, the access network device may send all the information in the system information to the terminal device based on the received wake up signal.

Optionally, the terminal device may alternatively obtain, based on two steps, the system information needed by the terminal device. For example, in a scenario in which the terminal device returns from out-of-coverage to in-coverage, the terminal device may send, to the access network device, a wake up signal used to trigger the access network device to send the first tag value in the system information. When the terminal device determines, based on the received first tag value sent by the access network device and a first tag value stored in the terminal device, that the system information stored in the terminal device is invalid, the terminal device may further send, to the access network device, a wake up signal used to trigger the access network device to send all the information in the system information, and therefore, the access network device may send all the information in the system information to the terminal device based on the received wake up signal.

Optionally, in a scenario in which the terminal device returns from out-of-coverage to in-coverage, the terminal device may alternatively send, to the access network device, a wake up signal that carries a first tag value stored in the terminal device. Therefore, the access network device may compare the received first tag value with a first tag value of a current network. When the received first tag value is different from the first tag value of the current network, the access network device may determine that the system information stored in the terminal device is invalid. Therefore, the access network device may send all the information in the system information to the terminal device. When the received first tag value is the same as the first tag value of the current network, the access network device may determine that the system information stored in the terminal device is valid. Therefore, the access network device may send an acknowledgment message to the terminal device, where the acknowledgment message may be carried in RRC signaling.

Optionally, in a cell reselection scenario, the terminal device may alternatively obtain, based on two steps, the system information needed by the terminal device. As shown in FIG. 6, after the terminal device performs cell reselection to determine a target cell, the terminal device may send, to the access network device, a wake up signal used to trigger the access network device to send the first part of information in the system information. Correspondingly, the access network device may send the first part of information to the terminal device based on the received wake up signal. Therefore, the terminal device may determine, based on the received first part of information, whether the terminal device can camp on the target cell, and if the terminal device cannot camp on the target cell, the terminal device performs cell reselection again; or if the terminal device can camp on the target cell, the terminal device further sends, to the access network device, a wake up signal used to trigger the access network device to send the second part of information in the system information, to further obtain the radio resource common configuration information, the timer configuration information, and the like.

Optionally, in some implementations 2, that the assistance information is used to trigger the access network device to send the part of information in the system information may further be: The assistance information is used to trigger the access network device to send Redcap-related configuration information, eMBB-related configuration information, URLLC-related configuration information, SDT-related configuration information, or the like in the system information.

For example, the Redcap-related configuration information may include one or more of a Redcap common configuration (redcap-ConfigCommon), an initial downlink part bandwidth of the RedCap (initialDownlinkBWP-RedCap), and the like in 3GPP TS 38.331.

For example, the eMBB-related configuration information may include one or more of information such as a Type A/slot based scheduling manner and K1 and K2 with a larger granularity. Herein, K1 indicates a time domain interval between a PDSCH and sending of an acknowledgment (ACK)/a negative acknowledgment (NACK), and K2 indicates a time interval between receiving of a scheduling indication in downlink control information (DCI) and uplink data transmission.

For example, the URLLC-related configuration information may include one or more of a Type B/non-slot based scheduling manner (a non-slot based scheduling manner, and a time domain scheduling granularity is a symbol level), a smaller value of K1, a smaller value of K2, a 2-step RACH configuration, and the like.

For example, the SDT-related configuration information may include one or more of small data transmission common configurations (sdt-ConfigCommon) in 3GPP TS 38.331.

Optionally, in some implementations 3, that the assistance information is used to trigger the access network device to send the part of information in the system information may further be: The assistance information is used to trigger the access network device to send UL-related configuration information, SUL-related configuration information, or the like in the system information.

For example, the UL-related configuration information may include an uplink common configuration parameter on a UL carrier, including frequency information of the UL carrier, an initial uplink bandwidth part (initial Uplink BWP) configuration, and a timing advance timer configuration.

For example, the SUL-related configuration information may include an uplink common configuration parameter on a SUL carrier, including frequency information of the SUL carrier, an initial uplink bandwidth part (initial Uplink BWP) configuration, and a timing advance timer configuration.

In a possible implementation (1), a manner in which the wake up signal indicates the assistance information may be that the wake up signal directly carries first indication information, and the first indication information indicates the assistance information, which is alternatively described as that the first indication information is used to trigger the access network device to send all or a part of information in the system information.

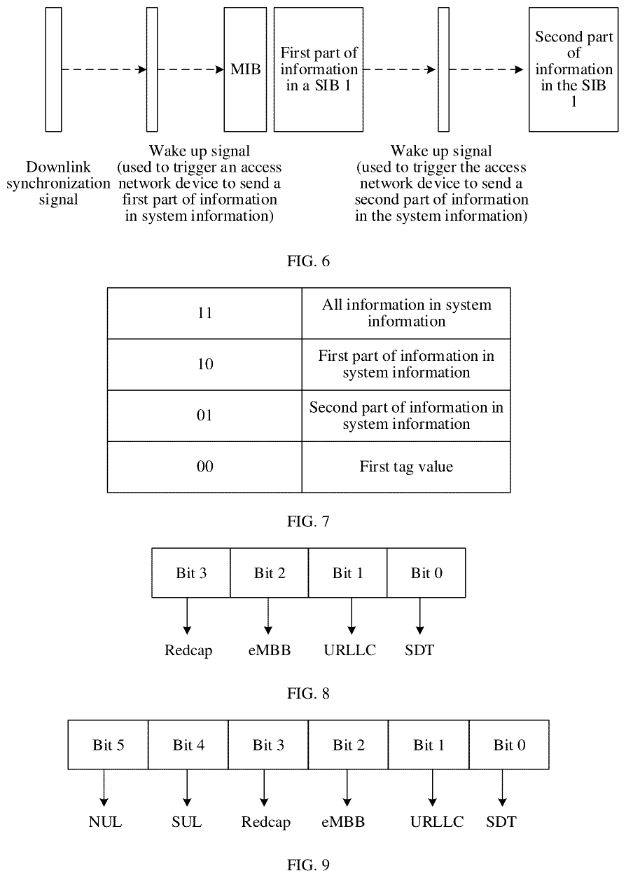

For example, the first indication information carried in the wake up signal is 2 bits. As shown in FIG. 7, when a value of the 2 bits is 11, it indicates that sending of all the information in the system information is triggered; when a value of the 2 bits is 10, it indicates that sending of the first part of information in the system information is triggered; when a value of the 2 bits is 01, it indicates that sending of the second part of information in the system information is triggered; or when a value of the 2 bits is 00, it indicates that sending of the first tag value (or referred to as a value tag) of the system information is triggered, where the first tag value is used to determine whether the system information stored in the terminal device is valid. Compared with a manner in which the access network device broadcasts all the information in the system information in a conventional technology, this on-demand obtaining manner in this application helps reduce network power consumption.

For another example, the first indication information carried in the wake up signal is 2 bits. As shown in FIG. 7, when a value of the 2 bits is 11, it indicates that sending of all the information in the system information is triggered; when a value of the 2 bits is 10, it indicates that sending of the first part of information in the system information is triggered; when a value of the 2 bits is 01, it indicates that sending of the second part of information in the system information is triggered; or a value of the 2 bits is a reserved value 00. Compared with a manner in which the access network device broadcasts all the information in the system information in the conventional technology, this on-demand obtaining manner in this application helps reduce network power consumption.

For another example, the first indication information carried in the wake up signal is 2 bits. It is assumed that the assistance information is a service type. When a value of the 2 bits is 11, it indicates that sending of Redcap-related configuration information in the system information is triggered; when a value of the 2 bits is 10, it indicates that sending of eMBB-related configuration information in the system information is triggered; when a value of the 2 bits is 01, it indicates that sending of URLLC-related configuration information in the system information is triggered; or when the value of the 2 bits is 00, it indicates that sending of the Redcap-related configuration information in the system information is triggered.

For another example, the first indication information carried in the wake up signal is a bitmap. Each bit corresponds to one service type. When a value of a corresponding bit is “1”, it indicates that the access network device is triggered to send corresponding configuration information. As shown in FIG. 8, a bit 0 corresponds to SDT, a bit 1 corresponds to URLLC, a bit 2 corresponds to eMBB, and a bit 3 corresponds to Redcap. When the first indication information is 1000, it indicates that the access network device is triggered to send the Redcap-related configuration information in the system message. When the first indication information is 0100, it indicates that the access network device is triggered to send the eMBB-related configuration information in the system message. When the first indication information is 0010, it indicates that the access network device is triggered to send the URLLC-related configuration information in the system message. When the first indication information is 0001, it indicates that the access network device is triggered to send the SDT-related configuration information in the system message. Alternatively, when the first indication information is 1100, it indicates that the access network device is triggered to send the Redcap-related configuration information and the eMBB-related configuration information in the system message; or when the first indication information is 1110, it indicates that the access network device is triggered to send the Redcap-related configuration information, the eMBB-related configuration information, and the URLLC-related configuration information in the system message. Details are not listed herein. Compared with a manner in which the access network device broadcasts configuration information of all service types in the system information in the conventional technology, this on-demand obtaining manner in this application helps reduce network power consumption.

For another example, the first indication information carried in the wake up signal is 2 bits. When a value of the 2 bits is 11, it indicates that the access network device is triggered to send the NUL-related configuration information in the system message. When a value of the 2 bits is 10, it indicates that the access network device is triggered to send the SUL-related configuration information in the system message. Compared with an implementation in which the access network device broadcasts both the NUL-related configuration information and the SUL-related configuration information in the conventional technology, this on-demand obtaining manner in this application helps reduce network power consumption.

It should be noted that a relationship between a value of the first indication information and a meaning corresponding to the value is merely an example. This is not limited in this application.

Optionally, various assistance information in this embodiment of this application may alternatively be combined. For example, the assistance information may include a service type and downlink signal received quality information. For example, the first indication information carried in the wake up signal may be an 8-bit bitmap. Each bit corresponds to one service type or downlink signal received quality information. When a value of a corresponding bit is “1”, it indicates that the access network device is triggered to send corresponding configuration information. As shown in FIG. 9, a bit 0 corresponds to SDT, a bit 1 corresponds to URLLC, a bit 2 corresponds to eMBB, a bit 3 corresponds to Redcap, a bit 4 corresponds to SUL (which is equivalent to that the downlink signal received quality is less than a signal quality threshold), and a bit 5 corresponds to NUL (which is equivalent to that the downlink signal received quality is greater than the signal quality threshold).

In a possible implementation (2), different wake up signals may be associated with/indicate different assistance information (which is alternatively described as that different wake up signals are used to trigger the access network device to send different information in the system information), where an association relationship between different wake up signals and different assistance information is predefined, preconfigured, or indicated by a first message. In other words, in addition to the additional first indication information, the assistance information may be indicated by the wake up signal.

It may be understood that “predefined” in embodiments of this application may be understood as that information is defined in a standard, does not need to be configured by another device (and cannot be changed by a network device or another terminal device), and is recorded/written in advance in hardware and/or software of the terminal device. “Preconfigured” may be understood as that information is recorded/written in advance in hardware and/or software of the terminal device, is determined by a device manufacturer, and may be changed by using software or hardware. “Indicated by a first message” is classified into being configured by using a first message sent by the network device and being configured by using a first message sent by the terminal device. If the configuration is performed by the network device, the first message may be radio resource control (RRC) signaling, a media access control-control element (MAC CE), a system information block (SIB), or the like. If the configuration is performed by the terminal device, the first message may be PC5-RRC signaling. For ease of description, an example in which the association relationship between different wake up signals and different assistance information is predefined in a protocol is mainly used below for schematic description.

It may be understood that the assistance information in this application includes one or more of a service type, service quality of service, downlink signal received quality information, and a wake up signal type (or referred to as a signal sending purpose, where for example, the signal sending purpose may be used to obtain all the information in the system information, or used to obtain the first part of information, or used to obtain the second part of information, or used to obtain the first flag value). The following describes the assistance information that is a service type, service quality of service of a service, downlink signal received quality information, and a wake up signal type.

For example, when the assistance information is the service type, the service type may include the following four types: \textcircled{1} Redcap, \textcircled{2} eMBB, \textcircled{3} URLLC, and \textcircled{4} SDT.

For another example, when the assistance information is the service quality of service (QoS) (or referred to as a QoS requirement, or a service QoS requirement), the service quality of service may be represented by using a quality class indicator (QCI) predefined in a protocol, a 5G QoS identifier (5QI), or another characteristic quantity defined in a future 6G system. The 5QI is used as an example. A mapping relationship (as shown in Table 1) between a standardized 5QI and a QoS characteristic is defined in Table 5.7.4-1 in 3GPP TS 23.501. Usually, the 5QI mainly includes one or more of the following QoS characteristics: a resource type, a default priority level (PL), a packet delay budget (PDB), a packet error rate (PER), a default maximum data burst volume (MDBV), a default averaging window (AW), and the like. For example, as shown in Table 1, when a 5QI value is 1, it indicates that a resource type is a guaranteed bandwidth (GBR) type, a priority level is 20, a packet delay budget is 100 ms, a packet error rate is 10⁻², a maximum data burst volume is a to-be-defined parameter, and an averaging window is 2000 ms.

It may be understood that 5QI values may be grouped in this application, for example, into a group 1, a group 2, a group 3, and a group 4. Each group includes one or more 5QI values, and one group corresponds to one service quality of service/QoS requirement. Based on this, an association relationship between each group and a wake up signal may be predefined in the protocol. Therefore, a corresponding service quality of service/QoS requirement of a service can be obtained by using the wake up signal.

For example, it is assumed that a grouping rule/basis of 5QI values is to group 5QI values whose packet delay budgets are in a range of (0 ms, 100 ms] into the group 1, group 5QI values whose packet delay budgets are in a range of (100 ms, 200 ms] into the group 2, group 5QI values whose packet delay budgets are in a range of (200 ms, 300 ms] into the group 3, and group 5QI values whose packet delay budgets are in a range of (300 ms, 1100 ms] into the group 4. In this case, the 5QI values included in the group 1 are respectively 85, 86, 87, 80, 82, 83, 88, 89, 90, 84, 3, 75, 79, 69, 65, 1, 66, 67, 5, and 7; the 5QI values included in the group 2 are respectively 2, 71, and 70; the 5QI values included in the group 3 are respectively 4, 72, 73, 6, and 8; and the 5QI values included in the group 4 are respectively 74, 76, and 9. It is predefined in the protocol that the group 1 is associated with/corresponds to a wake up signal 1, the group 2 is associated with/corresponds to a wake up signal 2, the group 3 is associated with/corresponds to a wake up signal 3, and the group 4 is associated with/corresponds to a wake up signal 4. If the terminal device sends the wake up signal 1 to the access network device, the access network device may determine, based on the wake up signal 1, that corresponding service quality of service is the group 1. Therefore, the access network device may send, based on the group 1, information that is in the system information and that meets the service quality of service.

It should be noted that the foregoing shows only an example in which a packet delay budget is used as a grouping rule/basis of the 5QI values. The grouping rule/basis of the 5QI values may be any one of a packet error rate, a maximum data burst volume, an averaging window, or the like. Alternatively, the grouping rule/basis of the 5QI values may be a combination of a plurality of parameters of a packet delay budget, a packet error rate, a maximum data burst volume, an averaging window, or the like. For example, the grouping rule/basis of the 5QI values may be a combination of a packet delay budget and a packet error rate. For another example, the grouping rule/basis of the 5QI values may be a combination of a packet delay budget, a packet error rate, and a maximum data burst volume. This is not enumerated one by one herein.

TABLE 1

| | | | | | Default | |
|---|---|---|---|---|---|---|
| | Re- | Default | Packet | Packet | maximum | Default |
| 5QI | source | priority | delay | error | data burst | averaging |
| value | type | level | budget | rate | volume | window |
| 1 | GBR | 20 | 100 ms | 10⁻² | N/A | 2000 ms |
| 2 | | 40 | 150 ms | 10⁻³ | N/A | 2000 ms |
| 3 | | 30 | 50 ms | 10⁻³ | N/A | 2000 ms |
| 4 | | 50 | 300 ms | 10⁻⁶ | N/A | 2000 ms |
| 65 | | 7 | 75 ms | 10⁻² | N/A | 2000 ms |
| 66 | | 20 | 100 ms | 10⁻² | N/A | 2000 ms |
| 67 | | 15 | 100 ms | 10⁻³ | N/A | 2000 ms |
| 75 | | 25 | 50 ms | 10⁻² | N/A | 2000 ms |
| 71 | | 56 | 150 ms | 10⁻⁶ | N/A | 2000 ms |
| 72 | | 56 | 300 ms | 10⁻⁴ | N/A | 2000 ms |
| 73 | | 56 | 300 ms | 10⁻⁸ | N/A | 2000 ms |
| 74 | | 56 | 500 ms | 10⁻⁸ | N/A | 2000 ms |
| 76 | | 56 | 500 ms | 10⁻⁴ | N/A | 2000 ms |
| 5 | Non- | 10 | 100 ms | 10⁻⁶ | N/A | N/A |
| 6 | GBR | 60 | 300 ms | 10⁻⁶ | N/A | N/A |
| 7 | | 70 | 100 ms | 10⁻³ | N/A | N/A |
| 8 | | 80 | 300 ms | 10⁻⁶ | N/A | N/A |
| 9 | | 90 | | | | |
| 10 | | 90 | 1100 ms | 10⁻⁶ | N/A | N/A |
| 69 | | 5 | 60 ms | 10⁻⁶ | N/A | N/A |
| 70 | | 55 | 200 ms | 10⁻⁶ | N/A | N/A |
| 79 | | 65 | 50 ms | 10⁻² | N/A | N/A |
| 80 | | 68 | 10 ms | 10⁻⁶ | N/A | N/A |
| 82 | Delay- | 19 | 10 ms | 10⁻⁴ | 255 bytes | 2000 ms |
| 83 | critical | 22 | 10 ms | 10⁻⁴ | 1354 bytes | 2000 ms |
| 84 | GBR | 24 | 30 ms | 10⁻⁵ | 1354 bytes | 2000 ms |
| 85 | | 21 | 5 ms | 10⁻⁵ | 255 bytes | 2000 ms |
| 86 | | 18 | 5 ms | 10⁻⁴ | 1354 bytes | 2000 ms |
| 87 | | 25 | 5 ms | 10⁻³ | 500 bytes | 2000 ms |
| 88 | | 25 | 10 ms | 10⁻³ | 1125 bytes | 2000 ms |
| 89 | | 25 | 15 ms | 10⁻⁴ | 17000 bytes | 2000 ms |
| 90 | | 25 | 20 ms | 10⁻⁴ | 63000 bytes | 2000 ms |

For another example, when the assistance information is the downlink signal received quality information, the downlink signal received quality information may be downlink signal received quality, a signal quality range to which the downlink signal received quality belongs, or indication information indicating whether the downlink signal received quality is greater than a signal quality threshold. For example, the downlink signal received quality information is the signal quality range (for example, a reference signal received power (RSRP) range) to which the downlink signal received quality belongs, and the signal quality range may include (−105 dBm, +∞) and (−∞, −105 dBm]. Optionally, when the assistance information is the indication information indicating whether the downlink signal received quality is greater than the signal quality threshold, the signal quality threshold may be predefined in a protocol, or preconfigured, or configured by the access network device by using RRC signaling, a MAC CE, or a SIB. For example, the signal quality threshold may be −105 dBm, and the assistance information may be indication information indicating that the downlink signal received quality is greater than the signal quality threshold, or the assistance information may be indication information indicating that the downlink signal received quality is not greater than the signal quality threshold. For another example, when the assistance information is the wake up signal type, the wake up signal type may include a wake up signal type I, a wake up signal type II, a wake up signal type III, and a wake up signal type IV.

The following separately describes different implementation solutions of the implementation (2).

In an implementation solution 1, the wake up signal may be an orthogonal sequence. Different orthogonal sequences are associated with/indicate different assistance information, which is alternatively described as that the different orthogonal sequences are used to trigger the access network device to send different information in the system information.

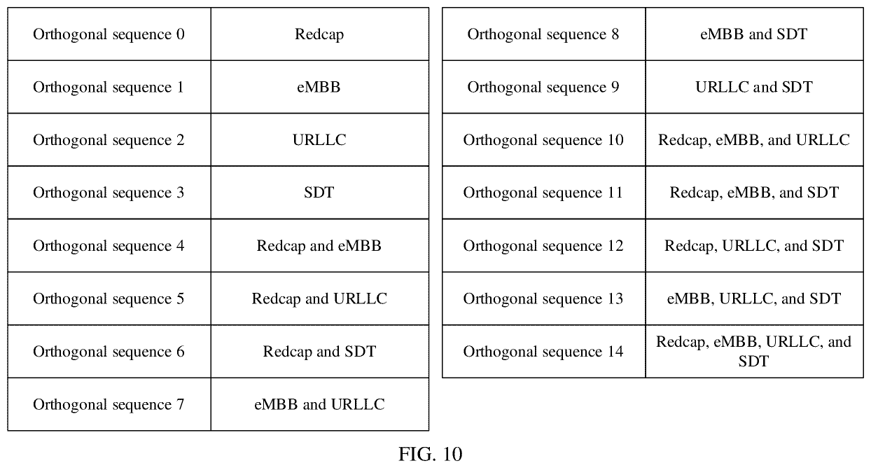

For example, as shown in FIG. 10, the assistance information is the service type. It is assumed that 15 orthogonal sequences are predefined in the protocol, and are respectively an orthogonal sequence 0 to an orthogonal sequence 14. In addition, it is predefined in the protocol: The orthogonal sequence 0 is associated with Redcap (or the orthogonal sequence 0 is used to trigger the access network device to send Redcap transmission-related configuration information in the system information); the orthogonal sequence 1 is associated with eMBB (or the orthogonal sequence 1 is used to trigger the access network device to send eMBB transmission-related configuration information in the system information); the orthogonal sequence 2 is associated with URLLC (or the orthogonal sequence 2 is used to trigger the access network device to send URLLC transmission-related configuration information in the system information); the orthogonal sequence 3 is associated with SDT (or the orthogonal sequence 3 is used to trigger the access network device to send SDT transmission-related configuration information in the system information); the orthogonal sequence 4 is associated with Redcap and eMBB (or the orthogonal sequence 0 is used to trigger the access network device to send the Redcap transmission-related configuration information and the eMBB transmission-related configuration information in the system information); the orthogonal sequence 5 is associated with Redcap and URLLC (or the orthogonal sequence 0 is used to trigger the access network device to send the Redcap transmission-related configuration information and the URLLC transmission-related configuration information in the system information); . . . ; and the orthogonal sequence 14 is associated with Redcap, eMBB, URLLC, and SDT (or the orthogonal sequence 14 is used to trigger the access network device to send the Redcap transmission-related configuration information, the eMBB transmission-related configuration information, the URLLC transmission-related configuration information, and the SDT transmission-related configuration information in the system information). When SDT transmission exists for the terminal device, the terminal device sends the orthogonal sequence 3 to the access network device on a determined time-frequency resource. After the access network device detects the orthogonal sequence 3, the access network device sends the SDT transmission-related configuration information in the system information.

For another example, the assistance information is the wake up signal type. It is assumed that four orthogonal sequences are predefined in the protocol, and are respectively an orthogonal sequence 0, an orthogonal sequence 1, an orthogonal sequence 2, and an orthogonal sequence 3. In addition, it is predefined in the protocol: The orthogonal sequence 0 is associated with the wake up signal type I (or the orthogonal sequence 0 is used to trigger the access network device to send all the information in the system information); the orthogonal sequence 1 is associated with the wake up signal type II (or the orthogonal sequence 1 is used to trigger the access network device to send the first tag value of the system information); the orthogonal sequence 2 is associated with the wake up signal type III (or the orthogonal sequence 2 is used to trigger the access network device to send the first part of information in the system information); and the orthogonal sequence 3 is associated with the wake up signal type IV (or the orthogonal sequence 3 is used to trigger the access network device to send the second part of information in the system information). When the terminal device sends the orthogonal sequence 3, and the access network device detects the orthogonal sequence 3, the access network device sends the second part of information in the system information.

For another example, the assistance information is the signal quality range to which the downlink signal received quality belongs. It is assumed that two orthogonal sequences are predefined in the protocol, and are respectively an orthogonal sequence 0 and an orthogonal sequence 1. In addition, it is predefined in the protocol: The orthogonal sequence 0 is associated with a signal quality range (−105 dBm, +∞) (or the orthogonal sequence 0 is used to trigger the access network device to send NUL-related configuration information in the system information); and the orthogonal sequence 1 is associated with a signal quality range (−∞, −105 dBm] (or the orthogonal sequence 1 is used to trigger the access network device to send SUL-related configuration information in the system information). When the terminal device sends the orthogonal sequence 0, and the access network device detects the orthogonal sequence 0, the access network device sends the NUL-related configuration information in the system information.

For another example, the assistance information is the indication information indicating whether the downlink signal received quality is greater than the signal quality threshold. It may be predefined in the protocol that downlink signal received quality corresponding to the orthogonal sequence 0 is greater than the signal quality threshold, and downlink signal received quality corresponding to the orthogonal sequence 1 is not greater than the signal quality threshold. When the terminal device sends the orthogonal sequence 0, and the access network device detects the orthogonal sequence 0, the access network device sends the NUL-related configuration information in the system information.

It should be noted that the association relationship between different orthogonal sequences and different assistance information is merely an example. A correspondence between the orthogonal sequence and a meaning corresponding to the orthogonal sequence is not limited in this embodiment of this application.

In an implementation solution 2, the wake up signal may be a chirp signal. Chirp signals with different start frequencies indicate different assistance information, which is alternatively described as that the chirp signals with different start frequencies are used to trigger the access network device to send different information in the system information.

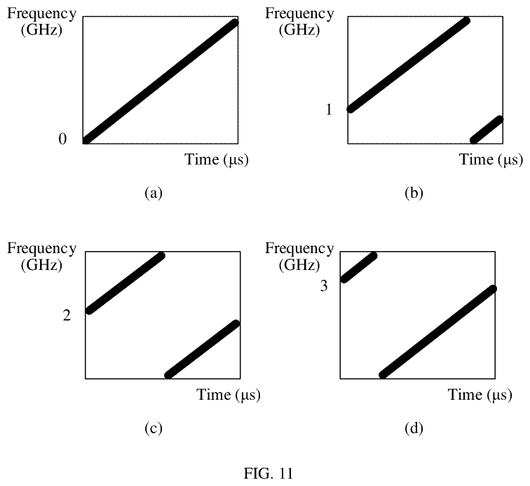

For example, FIG. 11 is a diagram of chirp signals with different start frequencies according to an embodiment of this application. Start frequencies of chirp signals shown in (a) to (d) in FIG. 11 are respectively 0 GHZ, 1 GHZ, 2 GHZ, and 3 GHz. For example, the assistance information is the service type. It is assumed that it is predefined in the protocol: The chirp signal whose start frequency is 0 GHz is associated with Redcap (or the chirp signal whose start frequency is 0 GHz is used to trigger the access network device to send Redcap transmission-related configuration information in the system information); the chirp signal whose start frequency is 1 GHz is associated with eMBB (or the chirp signal whose start frequency is 1 GHz is used to trigger the access network device to send eMBB transmission-related configuration information in the system information); the chirp signal whose start frequency is 2 GHz is associated with URLLC (or the chirp signal whose start frequency is 2 GHz is used to trigger the access network device to send URLLC transmission-related configuration information in the system information); and the chirp signal whose start frequency is 3 GHz is associated with SDT (or the chirp signal whose start frequency is 3 GHz is used to trigger the access network device to send SDT transmission-related configuration information in the system information). When SDT transmission exists for the terminal device, the terminal device may send the chirp signal whose start frequency is 3 GHz to the access network device. After the access network device detects the chirp signal whose start frequency is 3 GHZ, the access network device sends the SDT transmission-related configuration information in the system information.

For another example, the assistance information is the wake up signal type. It is assumed that it is predefined in the protocol: The chirp signal whose start frequency is 0 GHz is associated with a wake up signal type I (or it is predefined in the protocol that the chirp signal whose start frequency is 0 GHz is used to trigger the access network device to send all the information in the system information); the chirp signal whose start frequency is 1 GHz is associated with a wake up signal type II (or the chirp signal whose start frequency is 1 GHz is used to trigger the access network device to send the first tag value in the system information); the chirp signal whose start frequency is 2 GHz is associated with a wake up signal type III (or the chirp signal whose start frequency is 2 GHz is used to trigger the access network device to send the first part of information in the system information); and the chirp signal whose start frequency is 3 GHz is associated with a wake up signal type IV (or the chirp signal whose start frequency is 3 GHz is used to trigger the access network device to send the second part of information in the system information). When the terminal device sends the chirp signal whose start frequency is 3 GHz, if the access network device detects the chirp signal whose start frequency is 3 GHZ, the access network device sends the second part of information in the system information.

For another example, the assistance information is the signal quality range to which the downlink signal received quality belongs. It is assumed that it is predefined in the protocol: The chirp signal whose start frequency is 0 GHz is associated with a signal quality range (−105 dBm, +∞) (or it is predefined in the protocol that the chirp signal whose start frequency is 0 GHz is used to trigger the access network device to send NUL-related configuration information in the system information); and the chirp signal whose start frequency is 1 GHz is associated with a signal quality range (−∞, −105 dBm] (or the chirp signal whose start frequency is 1 GHz is used to trigger the access network device to send SUL-related configuration information in the system information). When the terminal device sends the chirp signal whose start frequency is 0 GHz, if the access network device detects the chirp signal whose start frequency is 0 GHz, the access network device sends the NUL-related configuration information in the system information.

Optionally, there may be a combination of various service types or various assistance information. Therefore, to ensure that the combination of various service types or the combination of various assistance information can be indicated, more association relationships between chirp signals with different start frequencies and the combination of various service types or the combination of various assistance information may be predefined.

In an implementation solution 3, different transmission resources used for transmission of the wake up signal may correspond to different assistance information. A time domain resource is used as an example. Different time domain offset values may be predefined to indicate different assistance information (which is alternatively described as that different time domain offset values are used to trigger the access network device to send different information in the system information). The time domain offset value is a time domain offset of a time domain resource that the wake up signal is on relative to a time domain resource that the downlink synchronization signal is on. Alternatively, a frequency domain resource is used as an example. It may be predefined that different frequency domain offset values indicate different assistance information (which is alternatively described as that the different frequency domain offset values are used to trigger the access network device to send different information in the system information). The frequency domain offset value is a frequency domain offset of a frequency domain resource that the wake up signal is on relative to a frequency domain resource that the downlink synchronization signal is on. It may be understood that the time domain offset of the time domain resource that the wake up signal is on relative to the time domain resource that the downlink synchronization signal is on may be specifically a time domain offset of start time of the time domain resource that the wake up signal is on relative to start time of the time domain resource that the downlink synchronization signal is on. The frequency domain offset of the frequency domain resource that the wake up signal is on relative to the frequency domain resource that the downlink synchronization signal is on may be specifically a frequency domain offset of a start frequency of the frequency domain resource that the wake up signal is on relative to a start frequency of the frequency domain resource that the downlink synchronization signal is on. Herein, the downlink synchronization signal may be a PSS or an SSS. For ease of description, the following mainly uses the PSS as an example for illustration.

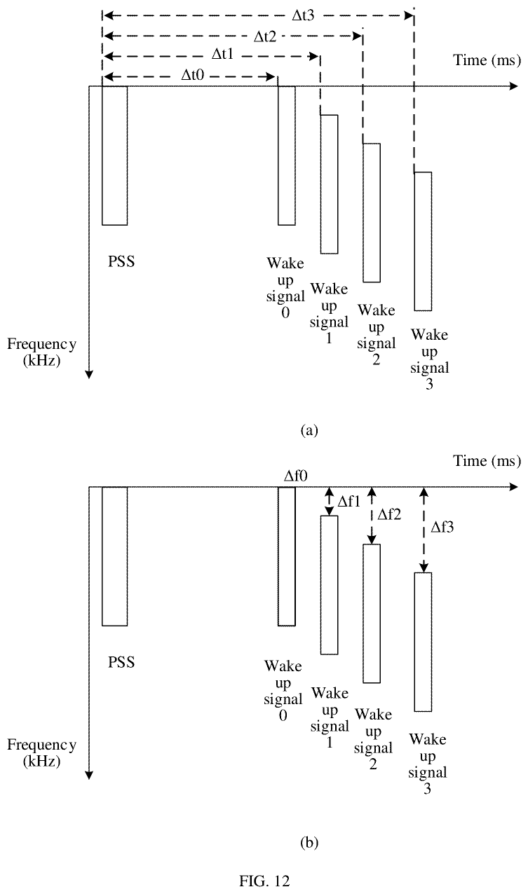

For example, FIG. 12 is a diagram of wake up signals on different transmission resources according to an embodiment of this application. As shown in (a) in FIG. 12, in time domain, a time domain offset of a time domain resource that a wake up signal 0 is on relative to the time domain resource that the downlink synchronization signal (that is, the PSS) is on is Δt0, a time domain offset of a time domain resource that a wake up signal 1 is on relative to the time domain resource that the PSS is on is Δt1, a time domain offset of a time domain resource that a wake up signal 2 is on relative to the time domain resource that the PSS is on is Δt2, and a time domain offset of a time domain resource that the wake up signal 3 is on relative to the time domain resource that the PSS is on is Δt3.

In an implementation, an example in which the assistance information is the service type is used. It may be predefined in the protocol: Δt0 is associated with Redcap (or Δt0 is used to trigger the access network device to send Redcap transmission-related configuration information in the system information); Δt1 is associated with eMBB (or Δt0 is used to trigger the access network device to send eMBB transmission-related configuration information in the system information); Δt2 is associated with URLLC (or t0 is used to trigger the access network device to send URLLC transmission-related configuration information in the system information); and Δt3 is associated with SDT (or to is used to trigger the access network device to send SDT transmission-related configuration information in the system information). When a time domain offset of a time domain resource of a wake up signal sent by the terminal device to the access network device relative to the time domain resource that the PSS is on is Δt0, system information subsequently sent by the access network device includes the Redcap transmission-related configuration information.

In another implementation, for example, the assistance information is the wake up signal type, it may be predefined in the protocol: Δt0 is associated with a wake up signal type I (or Δt0 is used to trigger the access network device to send all the information in the system information); Δt1 is associated with a wake up signal type II (or Δt1 is used to trigger the access network device to send the first tag value of the system information); Δt2 is associated with a wake up signal type III (or Δt2 is used to trigger the access network device to send the first part of information in the system information); and Δt3 is associated with a wake up signal type IV (or Δt3 is used to trigger the access network device to send the second part of information in the system information). When a time domain offset of a time domain resource of a wake up signal sent by the terminal device to the access network device relative to the time domain resource that the PSS is on is Δt0, the access network device sends all the information in the system information.

As shown in (b) in FIG. 12, in frequency domain, a frequency domain offset of a frequency domain resource that a wake up signal 0 is on relative to the frequency domain resource that the PSS is on is Δf0, a frequency domain offset of a frequency domain resource that a wake up signal 1 is on relative to the frequency domain resource that the PSS is on is Δf1, a frequency domain offset of a frequency domain resource that a wake up signal 2 is on relative to the frequency domain resource that the PSS is on is Δf2, and a frequency domain offset of a frequency domain resource that a wake up signal 3 is on relative to the frequency domain resource that the PSS is on is Δf3. In an implementation, an example in which the assistance information is the service type is used. Δf0 may be associated with Redcap, Δf1 may be associated with eMBB, Δf2 may be associated with URLLC, and Δf3 may be associated with SDT. Optionally, in another implementation, an example in which the assistance information is the wake up signal type is used. Δf0 may be associated with a wake up signal type I, Δf1 may be associated with a wake up signal type II, Δf2 may be associated with a wake up signal type III, and Δf3 may be associated with a wake up signal type IV.

For another example, the assistance information is the signal quality range to which the downlink signal received quality belongs. It is assumed that it is predefined in the protocol: A frequency domain offset value Δf0 is associated with a signal quality range (−105 dBm, +∞) (or it is predefined in the protocol that Δf0 is used to trigger the access network device to send NUL-related configuration information in the system information); and a frequency domain offset value Δf1 is associated with a signal quality range (−∞, −105 dBm] (or Δf1 is used to trigger the access network device to send SUL-related configuration information in the system information). When a frequency domain offset of a frequency domain resource of a wake up signal sent by the terminal device to the access network device relative to the frequency domain resource that the PSS is on is Δf0, the access network device sends the NUL-related configuration information in the system information.

Optionally, various assistance information in this embodiment of this application may alternatively be combined. For example, the assistance information may include a service type and downlink signal received quality information. If the wake up signal is an orthogonal sequence, more association relationships between orthogonal sequences and different assistance information need to be set. If the wake up signal is chirp signals with different start frequencies, more association relationships between chirp signals with start frequencies and different assistance information need to be set. If the assistance information is determined based on a resource offset value of the wake up signal and the downlink synchronization signal, more association relationships between resource offset values and different assistance information need to be set. Examples are not provided one by one herein in this application.

In this embodiment of this application, the wake up signal indicates the assistance information, and the assistance information is used to trigger on-demand sending of all or a part of content in the system information, so that overheads of the system information can be reduced, to help reduce network energy consumption.

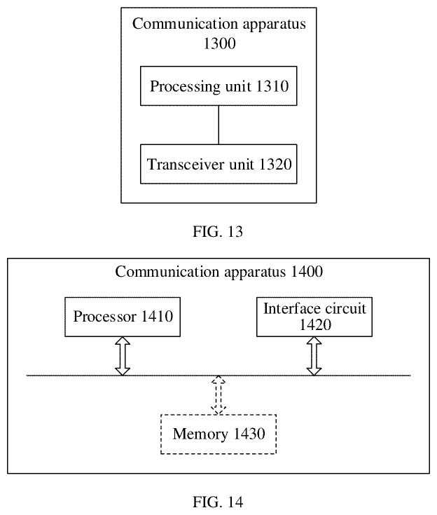

The following describes in detail communication apparatuses provided in this application with reference to FIG. 13 to FIG. 14.

It may be understood that, to implement functions in the foregoing embodiments, the communication apparatus includes corresponding hardware structures and/or software modules for performing the functions. A person skilled in the art should be easily aware that, in this application, the units and method steps in the examples described with reference to embodiments disclosed in this application can be implemented by hardware or a combination of hardware and computer software. Whether a function is performed by hardware or hardware driven by computer software depends on particular application scenarios and implementation constraint conditions of the technical solutions.

FIG. 13 and FIG. 14 are diagrams of structures of possible communication apparatuses according to embodiments of this application. The communication apparatuses may be configured to implement functions of the terminal device or the access network device in the foregoing method embodiment. Therefore, the beneficial effects of the foregoing method embodiment can also be achieved. In embodiments of this application, the communication apparatus may be one of the terminal devices 120a to 120j shown in FIG. 1, may be the access network device 110a or 110b shown in FIG. 1, or may be a module (for example, a chip) used in the terminal device or the access network device.

As shown in FIG. 13, a communication apparatus 1300 includes a processing unit 1310 and a transceiver unit 1320. The communication apparatus 1300 is configured to implement the functions of the terminal device or the access network device in the method embodiment shown in FIG. 4.

When the communication apparatus 1300 is configured to implement functions of the terminal device in the method embodiment shown in FIG. 4,
the transceiver unit 1320 is configured to receive a downlink synchronization signal from an access network device, where the downlink synchronization signal is used for downlink synchronization;
the transceiver unit 1320 is configured to send a wake up signal to the access network device, where the wake up signal indicates assistance information, and the assistance information is used to trigger the access network device to send all or a part of information in system information; and
the processing unit 1310 is configured to process the downlink synchronization signal and the like.

When the communication apparatus 1300 is configured to implement the functions of the access network device in the method embodiment shown in FIG. 4,
the transceiver unit 1320 is configured to send a downlink synchronization signal to a terminal device, where the downlink synchronization signal is used for downlink synchronization;
the transceiver unit 1320 is configured to receive a wake up signal from the terminal device, where the wake up signal indicates assistance information, and the assistance information is used to trigger an access network device to send all or a part of information in system information; and
the processing unit 1310 is configured to process the wake up signal and the like.

For more detailed descriptions of the processing unit 1310 and the transceiver unit 1320, refer to related descriptions in the method embodiment shown in FIG. 4.

As shown in FIG. 14, a communication apparatus 1400 includes a processor 1410 and an interface circuit 1420. The processor 1410 and the interface circuit 1420 are coupled to each other. It may be understood that the interface circuit 1420 may be a transceiver or an input/output interface. Optionally, the communication apparatus 1400 may further include a memory 1430, configured to: store instructions to be executed by the processor 1410, store input data needed for running instructions by the processor 1410, or store data generated after the processor 1410 runs instructions.

When the communication apparatus 1400 is configured to implement the method shown in FIG. 4, the processor 1410 is configured to implement the functions of the processing unit 1310, and the interface circuit 1420 is configured to implement the functions of the transceiver unit 1320.

When the communication apparatus is a chip used in a terminal device, the chip in the terminal device implements functions of the terminal device in the foregoing method embodiment. The chip in the terminal device receives, by using another module (for example, a radio frequency module or an antenna) in the terminal device, information sent by an access network device to the terminal device; or the chip in the terminal device sends information to another module (for example, a radio frequency module or an antenna) in the terminal device, where the information is sent by the terminal device to an access network device.

When the communication apparatus is a module used in an access network device, the module in the access network device implements functions of the access network device in the foregoing method embodiment. The module in the access network device receives information from another module (for example, a radio frequency module or an antenna) in the access network device, where the information is sent by a terminal device to the access network device; or the module in the access network device sends information to another module (for example, a radio frequency module or an antenna) in the access network device, where the information is sent by the access network device to a terminal device. The module in the access network device herein may be a baseband chip in the access network device, or may be a CU, a DU, or another module, or may be an apparatus in an open radio access network (O-RAN) architecture, for example, an apparatus like an open CU or an open DU.

It can be understood that the processor in embodiments of this application may be a central processing unit (CPU), or may be another general-purpose processor, a digital signal processor (DSP), an application-specific integrated circuit (ASIC), a field programmable gate array (FPGA) or another programmable logic device, a transistor logic device, a hardware component, or any combination thereof. The general-purpose processor may be a microprocessor or any regular processor or the like.

The method steps in embodiments of this application may be implemented in hardware, or may be implemented in software instructions that may be executed by the processor. The software instructions may include a corresponding software module. The software module may be stored in a random access memory, a flash memory, a read-only memory, a programmable read-only memory, an erasable programmable read-only memory, an electrically erasable programmable read-only memory, a register, a hard disk, a removable hard disk, a CD-ROM, or any other form of storage medium well-known in the art. For example, a storage medium is coupled to a processor, so that the processor can read information from the storage medium and write information into the storage medium. The storage medium may alternatively be a component of the processor. The processor and the storage medium may be disposed in an ASIC. In addition, the ASIC may be located in an access network device or a terminal device. The processor and the storage medium may alternatively exist as discrete components in the access network device or the terminal device.

All or a part of the foregoing embodiments may be implemented by using software, hardware, firmware, or any combination thereof. When software is used to implement embodiments, all or a part of embodiments may be implemented in a form of a computer program product. The computer program product includes one or more computer programs or instructions. When the computer programs or the instructions are loaded and executed on a computer, the procedures or functions in embodiments of this application are all or partially executed. The computer may be a general-purpose computer, a dedicated computer, a computer network, a network device, user equipment, or another programmable apparatus. The computer program or instructions may be stored in a computer-readable storage medium, or may be transmitted from a computer-readable storage medium to another computer-readable storage medium. For example, the computer program or instructions may be transmitted from a website, computer, server, or data center to another website, computer, server, or data center in a wired or wireless manner. The computer-readable storage medium may be any usable medium that can be accessed by the computer, or a data storage device, for example, a server or a data center, integrating one or more usable media. The usable medium may be a magnetic medium, for example, a floppy disk, a hard disk, or a magnetic tape; or may be an optical medium, for example, a digital video disc; or may be a semiconductor medium, for example, a solid-state drive. The computer-readable storage medium may be a volatile or non-volatile storage medium, or may include two types of storage media: a volatile storage medium and a non-volatile storage medium.

In embodiments of this application, unless otherwise stated or there is a logic conflict, terms and/or descriptions between different embodiments are consistent and may be mutually referenced, and technical features in different embodiments may be combined into a new embodiment based on an internal logical relationship thereof.

It may be understood that various numbers in embodiments of this application are merely used for differentiation for ease of description, and are not used to limit the scope of embodiments of this application. Sequence numbers of the foregoing processes do not mean an execution sequence, and the execution sequence of the processes should be determined based on functions and internal logic of the processes.

1. A communication method, comprising:
receiving a downlink synchronization signal from an access network device, wherein the downlink synchronization signal is used for downlink synchronization; and
sending a wake up signal to the access network device, wherein the wake up signal indicates assistance information used to trigger the access network device to send all or a part of system information.

2. The method according to claim 1, wherein the wake up signal comprises first indication information indicating the assistance information.

3. The method according to claim 1, wherein different wake up signals indicate different assistance information, and an association relationship between the different wake up signals and the different assistance information is predefined, preconfigured, or indicated by a first message.

4. The method according to claim 3, wherein the wake up signal is an orthogonal sequence, and different orthogonal sequences indicate the different assistance information.

5. The method according to claim 3, wherein the wake up signal is a chirp signal, and the different wake up signals indicate the different assistance information comprises:
chirp signals with different start frequencies indicate the different assistance information.

6. The method according to claim 3, wherein the different wake up signals indicate the different assistance information comprises:
different time domain offset values indicate the different assistance information, wherein a time domain offset value is a time domain offset of a time domain resource the wake up signal is on relative to the time domain resource the downlink synchronization signal is on, or
different frequency domain offset values indicate the different assistance information, wherein a frequency domain offset value is a frequency domain offset of a frequency domain resource the wake up signal is on relative to the frequency domain resource the downlink synchronization signal is on.

7. The method according to claim 1, wherein the assistance information comprises one or more of: a service type, a service quality, downlink signal received quality information, or a wake up signal type.

8. The method according to claim 7, wherein the service type comprises one or more of: reduced capability (Redcap), enhanced mobile broadband (eMBB), ultra-reliable low-latency communication (URLLC), or small data transmission (SDT).

9. The method according to claim 7, wherein the downlink signal received quality information is a downlink signal received quality, a signal quality range to which the downlink signal received quality belongs, or indication information indicating whether the downlink signal received quality is greater than a signal quality threshold.

10. The method according to claim 7, wherein the assistance information is used to trigger the access network device to send the part of the system information comprises:
the assistance information is used to trigger the access network device to send a first part of information, a second part of information, or a first tag value in the system information, the first tag value is used to determine whether the system information stored in a terminal device is valid, and all the information in the system information comprises the first part of information, the second part of information, and the first tag value.

11. A communication method, comprising:
sending a downlink synchronization signal to a terminal device, wherein the downlink synchronization signal is used for downlink synchronization; and
receiving a wake up signal from the terminal device, wherein the wake up signal indicates assistance information used to trigger an access network device to send all or a part of system information.

12. The method according to claim 11, wherein the wake up signal comprises first indication information indicating the assistance information.

13. The method according to claim 11, wherein different wake up signals indicate different assistance information, and an association relationship between the different wake up signals and the different assistance information is predefined, preconfigured, or indicated by a first message.

14. The method according to claim 13, wherein the wake up signal is an orthogonal sequence, and different orthogonal sequences indicate the different assistance information.

15. The method according to claim 13, wherein the wake up signal is a chirp signal, and the different wake up signals indicate the different assistance information comprises:
chirp signals with different start frequencies indicate the different assistance information.

16. The method according to claim 13, wherein the different wake up signals indicate the different assistance information comprises:
different time domain offset values indicate the different assistance information, wherein a time domain offset value is a time domain offset of a time domain resource the wake up signal is on relative to the time domain resource the downlink synchronization signal is on, or
different frequency domain offset values indicate the different assistance information, wherein a frequency domain offset value is a frequency domain offset of a frequency domain resource the wake up signal is on relative to the frequency domain resource the downlink synchronization signal is on.

17. The method according to claim 11, wherein the assistance information comprises one or more of: a service type, service quality, downlink signal received quality information, or a wake up signal type.

18. The method according to claim 17, wherein the service type comprises one or more of: reduced capability (Redcap), enhanced mobile broadband (eMBB), ultra-reliable low-latency communication (URLLC), or small data transmission (SDT).

19. The method according to claim 17, wherein the downlink signal received quality information is a downlink signal received quality, a signal quality range to which the downlink signal received quality belongs, or indication information indicating whether the downlink signal received quality is greater than a signal quality threshold.

20. A communication apparatus, comprising:
at least one processor configured to cause, by running a computer program or instructions or using a logic circuit, the communication apparatus to:
receive a downlink synchronization signal from an access network device, wherein the downlink synchronization signal is used for downlink synchronization; and
send a wake up signal to the access network device, wherein the wake up signal indicates assistance information used to trigger the access network device to send all or a part of system information.
